(19) United States
(12) Patent Application Publication
(10) Pub. No.: US 2012/0327651 A1
(43) Pub. Date: Dec. 27, 2012

(54) Light-emitting textile-based architectural element

(75) Inventors: Hugo Johan Cornelssen, Waalre (NL); Rabin Bhattacharya, Silver Spring, MD (US); Wouter Bastiaan Zeper, Eindhoven (NL)

(73) Assignee: KONINKLIJKE PHILIPS ELECTRONICS, N.V., EINDHOVEN (NL)

(21) Appl. No.: 13/583,087

(22) PCT Filed: Mar. 10, 2011
(86) PCT No.: PCT/IB11/50999

§ 371 Date: Sep. 6, 2012

(30) Foreign Application Priority Data
Mar. 16, 2010 (EP) 10156619.8

(51) Int. Cl. F21V 21/00; F21V 11/00; F21V 7/00

(52) U.S. Cl. 362/231; 362/235; 362/249.01

(57) ABSTRACT

A light-emitting textile-based architectural element (1), comprising a frame (4); and a first textile sheet (5) being tensioned by the frame (4) to cover an area defined by the frame (4). The first textile-sheet (5) is a light-emitting electronic textile comprising a textile substrate (6) having a preformed conductor pattern (7a-b); and a plurality of light sources (8) attached to the textile substrate (6) in such a way that each light source (8) is electrically connected to the conductor pattern (7a-b).

### FIELD OF THE INVENTION

The present invention relates to a light-emitting textile-based architectural element, and to a method of manufacturing such a light-emitting textile-based architectural element.

### BACKGROUND OF THE INVENTION

Textiles are used in many aspects of our every-day lives. One of the largest markets for textiles is in wearable fashion and fashion accessories. Besides this market, textiles are also commonly used in interior settings as upholstery for furniture and as carpet for flooring. This interior market also includes a growing category of textiles that are used as architectural elements.

Textiles have been used in architecture for thousands of years, mostly serving the dual use of decoration and heat insulation (i.e. wall tapestries).

Recently, textiles and lighting has been combined to form textile-based architectural elements. One example of such a light-emitting textile-based architectural element is a textile screen formed by a textile stretched over a frame to form a free-standing structure. Inside the structure, color controllable light sources are arranged to project light on the textile, whereby appealing visual effects can be achieved.

Although being capable of providing appealing visual effects, such light-emitting textile-based architectural elements are mainly useful for temporary installation, for example in connection with promotional events, since they are free-standing and rather bulky.

### SUMMARY OF THE INVENTION

In view of the above-mentioned and other drawbacks of the prior art, a general object of the present invention is to provide an improved light-emitting textile-based architectural element, in particular a more compact light-emitting textile-based architectural element.

According to a first aspect of the present invention there is provided a light-emitting textile-based architectural element, comprising a frame, and a first textile sheet being tensioned by the frame to cover an area defined by the frame, wherein the first textile-sheet is a light-emitting electronic textile comprising a textile substrate having a preformed conductor pattern, and a plurality of light sources attached to the textile substrate in such a way that each light source is electrically connected to the conductor pattern.

That the conductor pattern is “preformed” on the textile substrate should, in the context of the present application, be understood to mean that the conductor pattern is formed in or on the textile substrate prior to attachment of the light sources.

By “textile sheet” should, in the context of the present application, be understood a sheet that is wholly or partly made of fibers. The fibers may be provided in the form of single fibers/filaments, or they may be bundled together in a multi-fiber configuration, such as a yarn. The textile may, for example, be manufactured by means of weaving, braiding, knitting, crocheting, quilting, or felting. In particular, the textile may be woven or non-woven.

The present invention is based on the realization that a relatively compact and visually attractive light-emitting textile-based architectural element can be achieved by tensioning a first textile sheet in the form of a light-emitting electronic textile across a frame that defines the outline of the light-emitting textile-based architectural element. The present inventors have further realized that sufficient reliability of such a light-emitting textile-based architectural element, which may typically be in the high-end scale of textile-based architectural elements, can be achieved in particular by providing the first textile sheet in the form of a light-emitting electronic textile comprising a textile substrate. A textile substrate can be subjected to various stresses associated with tensioning of the first textile sheet without suffering from loss of function. For example, a textile substrate can be clamped, bent and stretched to a tensioned state without damaging the textile substrate. Other flexible substrates, such as flexible printed circuit boards are typically considerably more sensitive to bending (particularly repeated bending) and stretching etc.

In this context, it should be noted that the term “tensioned” as used herein implies that the first textile sheet will continuously be subjected to a stretching force, so as to keep the first textile sheet substantially flat (at least between two frame parts). That the first textile sheet is tensioned by the frame thus involves more severe requirements on the first textile sheet than would have been the case had it been loosely supported by the frame or draped over the frame.

The first textile sheet may advantageously be a pre-produced light-emitting electronic textile, which can be manufactured in a rational manufacturing process that is adapted to standardized and efficient textile manufacturing processes. This means that no or very minor additional process steps are required to form the light-emitting textile-based architectural element.

According to various embodiments of the invention, the light-emitting textile-based architectural element may be substantially flat, and be configured to be mounted on a wall or ceiling etc.

The light-emitting textile-based architectural element may advantageously further comprise a second textile sheet arranged substantially in parallel with the first textile sheet.

This second textile sheet may, for example, be provided in the form of a cover textile that is arranged to cover light sources comprised in the first textile layer, whereby the light emitted by the light sources can be optically diffused so that the light is output from the light-emitting textile-based architectural element across a larger surface area thereof. At the same time, the maximum intensity of the light is reduced. Hereby, more appealing lighting effects can be presented to a user/viewer of the light-emitting textile-based architectural element (typically someone who is present in a room or similar where the light-emitting textile-based architectural element is arranged).

To further increase the optical diffusion of light output by the light sources, the first textile sheet may additionally comprise a light-spreading sheet arranged between the textile substrate and the cover textile. The light-spreading sheet may serve to only space apart the light sources and the cover textile, to thereby allow the light output by the light sources to spread over a larger area before hitting the cover textile. Alternatively, the light-spreading sheet may be configured to space apart the light sources and the cover textile and to optically diffuse the light output by the light sources through interaction between the light-spreading sheet and the light output by the light sources.

As an alternative or complement to such a cover textile being comprised in the first textile sheet, the second textile sheet may be tensioned by the frame and spaced apart from the first textile sheet. By providing the second textile sheet in this manner, the functionality of the light-emitting textile-based architectural element can be extended to damping sound, which may be an important property of the light-emitting textile-based architectural element depending on application.

The light sources comprised in the first textile sheet may advantageously be arranged to emit light towards the second textile sheet. Hereby, an efficient optical diffusion can be achieved in a compact arrangement. This may be achieved by allowing the light that is output by the light sources to pass through the second textile sheet before the light reaches the user, so that the light can spread out due to the distance between the first textile sheet and the second textile sheet, and then be diffused further upon passage through the second textile sheet. In this embodiment, the second textile sheet may advantageously be arranged to be facing the user when the light-emitting textile-based architectural element is in use.

Alternatively, the first textile sheet may be arranged between the second textile sheet and a position for viewing the light-emitting textile-based architectural element when in use, so that light emitted by the light sources comprised in the first textile sheet can be reflected by the second textile sheet before passing through the first textile sheet to exit from the light-emitting textile-based architectural element.

In this embodiment, the light that is output by the light sources comprised in the first textile sheet travels twice the distance between the first textile sheet and the second textile sheet before the light exits the light-emitting textile-based architectural element through the first textile sheet to continue towards the user. This increases the spreading of the light or alternatively allows for a smaller spacing between the first textile sheet and the second textile sheet for achieving a given optical diffusion of the light that is output by the light-emitting textile-based architectural element. Furthermore, the optical diffusion of the light can be increased even further, since the reflection of the light at the second textile sheet may be made diffuse by providing a second textile sheet which is made of a diffusely reflective material.

According to various embodiments of the present invention, the light-emitting textile-based architectural element may advantageously comprise a plurality of individually controllable light sources. Hereby, the output of the light-emitting textile-based architectural element can be controlled to vary to create different light-effects depending on application and situation, whereby, for example, an ambience can be created.

Since the individually controllable light sources are provided on a textile substrate having a preformed conductor pattern and since this textile substrate is tensioned by the frame, the individually controllable light sources can be positioned on the light-emitting textile-based architectural element with a high level of accuracy and repeatability. Furthermore, this can be done in a simple process, which keeps down the cost of manufacturing of the light-emitting textile-based architectural element.

The plurality of individually controllable light sources may advantageously comprise a first set of light sources controllable to emit light of a first color; and a second set of light sources controllable to emit light of a second color, different from the first color. Hereby, color effects can be achieved. The first color and the second color may, for example, be different primary colors that can be used to form other colors. Examples of primary colors are red, green, blue, amber, etc.

The above-mentioned individually controllable light sources may, furthermore, advantageously be arranged to define individually addressable pixels, which allows for the formation of a large variety of user-defined patterns on the light-emitting textile-based architectural element. In this embodiment, it is of particular importance that the light sources are at well-defined locations, at least relative each other. Such well-defined locations can be achieved in a cost-efficient, reliable and repeatable manner through the various aspects of the present invention. In particular the tensioning of a pre-manufactured light-emitting electronic textile comprising a textile substrate having a preformed conductive pattern with a plurality of light sources connected thereto greatly facilitates providing the individually controllable light sources at well-defined locations, at least relative each other.

According to various embodiments of the present invention, the textile substrate comprised in the first textile sheet may include at least one textile ribbon. This is a convenient way of providing the light-emitting electronic textile. For example, the light sources may be attached to the textile ribbon and electrically connected to a preformed conductor pattern included in the textile ribbon. The textile ribbon may advantageously be attached to a supporting fabric, whereby light sources can conveniently be arranged in well-defined locations relative each other.

Moreover, in various embodiments of the light-emitting textile-based architectural element according to the invention, the conductor pattern included in the textile substrate may comprise at least one conductive fiber, which may be provided to the textile substrate in various ways. For example, the at least one conductive fiber may be interwoven in the textile substrate, or may be provided through several methods including crocheting, knitting, sewing, etc. The conductor pattern may, for instance, be formed by at least one conductive yarn.

Furthermore, the light-emitting textile-based architectural element according to the present invention may additionally comprise a connector for allowing connection of the light sources to a control unit.

Additionally, the light-emitting textile-based architectural element may advantageously comprise a control unit being connected to the light sources via the above-mentioned connector. The control unit may, for example, conveniently be integrated in the light-emitting textile-based architectural element by attaching the control unit to the frame.

According to a second aspect of the present invention, there is provided a method of manufacturing a light-emitting textile-based architectural element, comprising the steps of providing a frame and a pre-produced light-emitting electronic textile sheet; tensioning the pre-produced light-emitting electronic textile sheet across the frame in such a way that the pre-produced light-emitting electronic textile sheet covers an area defined by the frame.

Variations and advantages of this second aspect of the present invention are largely analogous to those provided above in connection with the first aspect of the invention.

### BRIEF DESCRIPTION OF THE DRAWINGS

These and other aspects of the present invention will now be described in more detail, with reference to the appended drawings showing currently preferred embodiments of the invention, wherein:

FIG. 1 schematically illustrates a light-emitting textile-based architectural element according to an exemplary embodiment of the present invention;

FIG. 2 is a schematic cross-section view of the light-emitting textile-based architectural element in FIG. 1, showing one exemplary configuration of the light-emitting textile-based architectural element;

FIGS. 3a-c are section views of a portion of the light-emitting textile-based architectural element in FIG. 1, schematically illustrating different exemplary configurations of the light-emitting textile-based architectural element;

FIGS. 4a-b schematically illustrate an example of the light-emitting electronic textile comprised in the light-emitting textile-based architectural element, in which the textile substrate comprises textile ribbons arranged on a supporting fabric; and

FIG. 5 is a flow-chart schematically illustrating an embodiment of the method according to the present invention.

### DESCRIPTION OF A PREFERRED EMBODIMENT OF THE PRESENT INVENTION

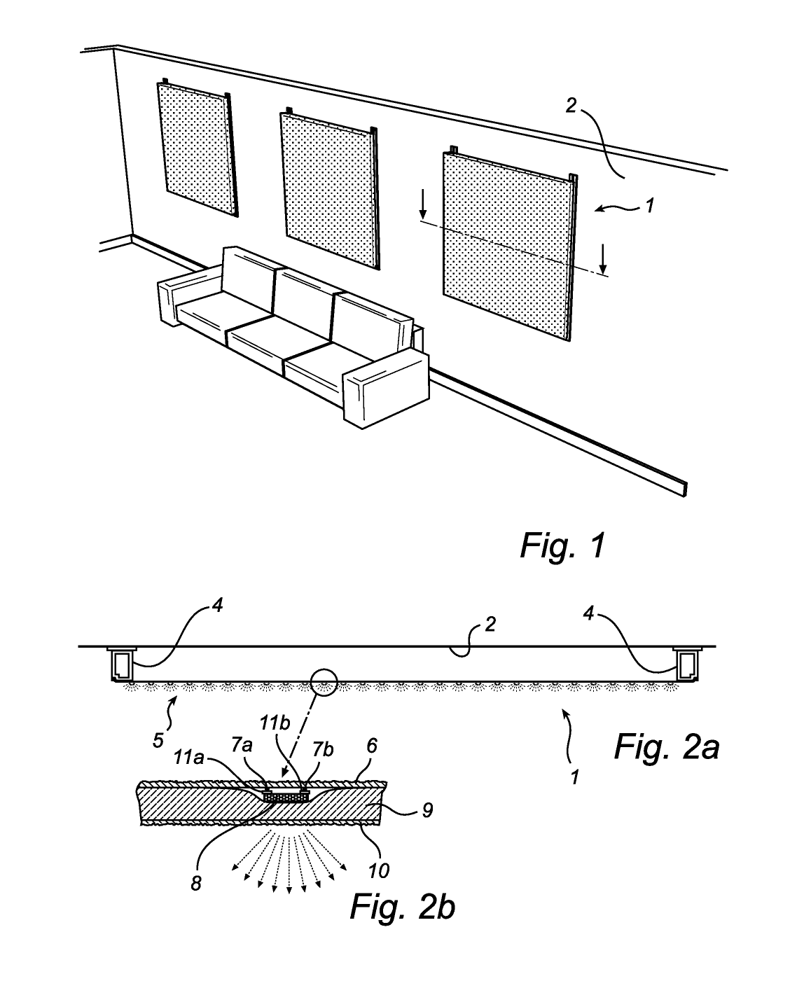

FIG. 1 schematically illustrates a light-emitting textile-based architectural element 1 arranged on a wall 2. Through the light-emitting textile-based architectural element 1, an ambience can be created in the room. In typical applications, the ambience can be controlled by controlling various features of the light-emitting textile-based architectural element 1, such as the light-output pattern, the intensity of the light that is output and/or the color of the light.

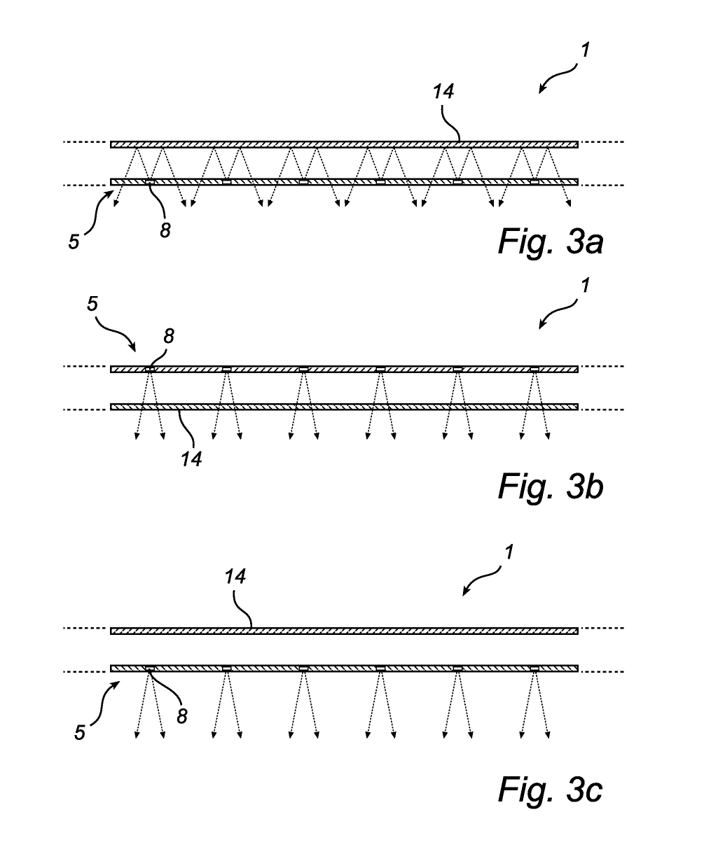

FIG. 2 is a cross-section view of the light-emitting textile-based architectural element 1 in FIG. 1, which schematically illustrates an exemplary configuration of the light-emitting textile-based architectural element 1. Further exemplary configurations of the light-emitting textile-based architectural element in FIG. 1 will be described further below with reference to FIGS. 3a-c.

With reference to FIG. 2, the light-emitting textile-based architectural element 1 according to this first exemplary configuration comprises a frame 4, and a first textile sheet 5 in the form of a light-emitting electronic textile. The first textile sheet 5 is tensioned by the frame 4 so that the first textile sheet 5 exhibits a flat and even surface to a user. As will be easily understood by the skilled person, the textile sheet 5 may be tensioned by the frame 4 in various ways, for example using springs etc, and the frame configuration indicated in FIG. 2 is simply intended as an illustrative example of one of numerous possible frame configurations.

As can be best seen in the enlarged portion of FIG. 2, the first textile sheet 5 comprises a textile substrate 6 with conductors 7a-b arranged thereon, a plurality of light sources 8 in the form of light-emitting diodes (LEDs) (for the sake of clarity of drawing, only one of the light sources is indicated by a reference numeral), an optically diffusing sheet 9 and a cover textile 10. The LEDs 8 are attached to the textile substrate 6 in such a way that contact pads 11a-b of the LEDs 8 are electrically connected to the conductors 7a-b. To reduce glare and present a diffuse light to the user of the light-emitting textile-based architectural element 1, the optically diffusing sheet 9 and the cover textile 10 are arranged to allow the light that is output by the LEDs 8 to pass through the optically diffusing sheet 9 and the cover textile 10 before reaching the user.

FIGS. 3a-c are section views of a portion of the light-emitting textile-based architectural element 1 in FIG. 1, schematically illustrating different exemplary configurations of the light-emitting textile-based architectural element 1. In all of the exemplary configurations that are schematically shown in FIGS. 3a-c, the light-emitting textile-based architectural element 1 comprises a second textile sheet 14 that is spaced apart from the first textile sheet 5, and that is also tensioned in the frame 4. Through each of these configurations, efficient acoustic damping can be achieved, which is a very attractive feature for various applications, such as in offices etc.

Turning first to FIG. 3a, a first exemplary configuration of the light-emitting textile-based architectural element 1 in FIG. 1 is shown, which differs from that shown in FIG. 2 in that the light-emitting textile-based architectural element 1 comprises a second textile sheet 14 arranged behind the first textile sheet 5 relative the position of a user of the light-emitting textile-based architectural element 1, and in that the light sources 8 are arranged to output light away from the user.

In this exemplary configuration, the second textile sheet 14 is at least partly reflective, so that the light that is output by the light sources 8 is reflected by the second textile sheet 14 and exits the light-emitting textile-based architectural element 1 through the first textile sheet 5, as is schematically indicated in FIG. 3a. Through this configuration, very efficient optical diffusion can be achieved in a compact light-emitting textile-based architectural element 1. In particular, the light-emitting textile-based architectural element 1 can be made thin, since the light travels twice the distance between the first textile sheet 5 and the second textile sheet 14 before it exits the light-emitting textile-based architectural element 1. Furthermore, the reflection at the second textile sheet 14 and the passage through the first textile sheet 5 diffuses the light even further.

With reference to FIG. 3b, another exemplary configuration of the light-emitting textile-based architectural element 1 in FIG. 1 will now be described. In the configuration that is schematically illustrated in FIG. 3b, the second textile sheet 14 is arranged in front of the first textile sheet 5, and the LEDs 8 in the first textile sheet are arranged to output light through the second textile sheet 14 towards the user of the light-emitting textile-based architectural element 1. Hereby, the light is spread out while passing through the space between the first textile sheet 5 and the second textile sheet 14, and additionally optically diffused upon passage through the second textile sheet 14.

Finally, FIG. 3c schematically illustrates a further exemplary configuration of the light-emitting textile-based architectural element 1 in FIG. 1, which differs from that shown in FIG. 2 in that a second textile sheet 14 is arranged behind the first textile sheet 5. Hereby, the above-mentioned improved acoustic damping can be achieved.

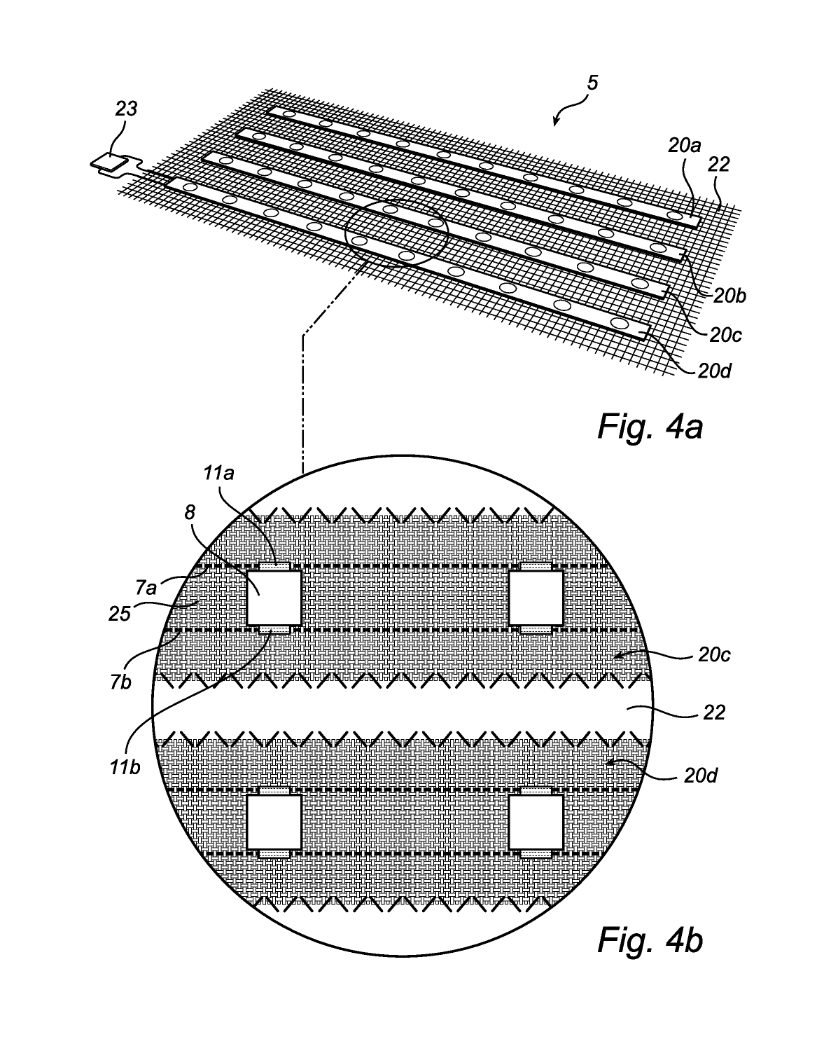

FIGS. 4a-b schematically illustrate an example of the light-emitting electronic textile 5 comprised in the light-emitting textile-based architectural element 1, in which the textile substrate 6 comprises textile ribbons 20a-d each having a preformed conductor pattern 21a-b, attached to a fabric 22.

The LEDs 8 in each textile ribbon 20a-d may be electrically connected to a control unit 23. The control unit 23 may be attached to the first textile sheet 5, or may advantageously be arranged external to the first textile sheet 5 and be electrically connected thereto through suitable wiring. In the latter case, the control unit 23 may for example be attached to the frame 4 of the light-emitting textile-based architectural element 1.

In any case, the control unit 23 may either directly control the current/voltage provided to each LED 8, or each LED-arrangement 8 may comprise one or several electronic components (not shown) that may receive higher level control signals from the control unit 23.

The textile ribbons 20a-d are here, as can be seen in FIG. 4b, provided in the form of woven ribbons formed by interwoven conductive 21a-b and non-conductive 25 yarns. The conductive yarns 21a-b may have a conductive outer surface, and are not short-circuited because they are separated by several non-conductive yarns 25.

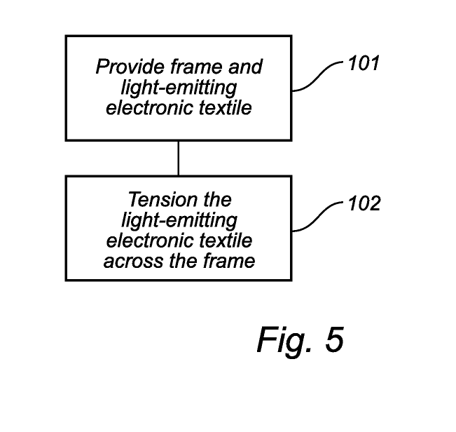

The textile ribbons 20a-d are stitched to the fabric 22 as is schematically illustrated in FIG. 4b. As will be evident to the skilled person, the textile ribbons can be attached to the fabric 22 in various other ways depending on application. Examples of other ways of attaching the textile ribbons 20a-d to the fabric 22 include, for example, gluing, clamping, ultrasonic welding, etc. Moreover, the fabric 22 may include one or several preformed holding structure(s) for keeping the textile ribbons 20a-d in place. Such preformed holding structures may, for example, be formed by loops, or be provided in the form of pockets or channels. Finally, an embodiment of the method according to the present invention will be described with reference to the flow-chart in FIG. 5.

In a first step 101, a frame 4 and a pre-produced light-emitting electronic textile 5 are provided. The pre-produced light-emitting electronic textile 5 is then arranged on the frame 4 in such a way that it is tensioned by the frame 4, in step 102.

Additionally, variations to the disclosed embodiments can be understood and effected by the skilled person in practicing the claimed invention, from a study of the drawings, the disclosure, and the appended claims. For example, the first textile sheet may comprise light sources arranged to emit light in opposite directions. Furthermore, the light-emitting textile-based architectural element may comprise more than one textile sheet in the form of a light-emitting electronic textile.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A light-emitting textile-based architectural element, comprising:
a frame; and
a first textile sheet being tensioned by the frame to cover an area defined by the frame, wherein the first textile sheet is a light-emitting electronic textile comprising:
a textile substrate having a preformed conductor pattern; and
a plurality of light sources attached to the textile substrate in such a way that each light source is electrically connected to the conductor pattern.

2. The light-emitting textile-based architectural element according to claim 1, further comprising a second textile sheet arranged substantially in parallel with the first textile sheet.

3. The light-emitting textile-based architectural element according to claim 2, wherein the second textile sheet is tensioned by the frame and spaced apart from the first textile sheet.

4. The light-emitting textile-based architectural element according to claim 2, wherein the light sources comprised in the first textile sheet are arranged to emit light towards the second textile sheet.

5. The light-emitting textile-based architectural element according to claim 4, wherein the second textile sheet is arranged between the first textile sheet and a position for viewing the light-emitting textile-based architectural element when in use.

6. The light-emitting textile-based architectural element according to claim 4, wherein the first textile sheet is arranged between the second textile sheet and a position for viewing the light-emitting textile-based architectural element when in use, so that light emitted by the light sources comprised in the first textile sheet can be reflected by the second textile sheet before passing through the first textile sheet to exit from the light-emitting textile-based architectural element.

7. The light-emitting textile-based architectural element according to claim 4, wherein the first textile sheet comprises a plurality of individually controllable light sources.

8. The light-emitting textile-based architectural element according to claim 7, wherein the plurality of individually controllable light sources comprises:
a first set of light sources controllable to emit light of a first color; and
a second set of light sources controllable to emit light of a second color, different from the first color.

9. The light-emitting textile-based architectural element according to claim 7, wherein the light sources are arranged to define individually addressable pixels.

10. The light-emitting textile-based architectural element according to claim 7, wherein the first textile sheet further comprises a light-diffusing element arranged to diffuse light emitted by at least one of the light sources.

11. The light-emitting textile-based architectural element according to claim 7, wherein the textile substrate comprises:
a fabric; and
at least one textile ribbon having a preformed conductor pattern, wherein the at least one textile ribbon is attached to the fabric.

12. The light-emitting textile-based architectural element according to claim 7, wherein the conductor pattern comprises at least one conductive fiber.

13. The light-emitting textile-based architectural element according to claim 7, further comprising a connector for facilitating connection of the light sources to a control unit.

14. The light-emitting textile-based architectural element according to claim 13, further comprising a control unit which is connected to the light sources via the connector.

15. (canceled)
